(19) United States
(12) Patent Application Publication
(10) Pub. No.: US 2005/0289003 A1
(43) Pub. Date: Dec. 29, 2005

(54) System and method for direct marketing

(76) Inventors: R. Mark Thompson, Belmont, MI (US); Valerie Betten, Grand Rapids, MI (US); Kay A. VandenElst, Grand Rapids, MI (US)

Correspondence Address: BRINKS HOFER GILSON & LIONE, P.O. BOX 10395, CHICAGO, IL, 60610, US

(21) Appl. No.: 11/061,915

(22) Filed: Feb. 18, 2005

Related U.S. Application Data
(60) Provisional application No. 60/546,613, filed on Feb. 20, 2004.

(51) Int. Cl. G06F 17/00

(52) U.S. Cl. 705/14

(57) ABSTRACT

A method of marketing and selling products or services through a marketing system is disclosed. The method may include: maintaining, by the marketing system, a database in a memory of a computer, the database including a plurality of data records, each data record associated with a participant of the marketing system and assigned a first attribute if the associated participant is also a member of a second marketing system; receiving, at an interface of the computer coupled with the memory, from a first participant, a request to register in the marketing system, the request including an indication that the first participant is also a member of the second marketing system; creating, by the computer, a first data record in the database based on the received request, the first data record being associated with the first participant and assigned the first attribute based on the indication; accounting, by the computer, for a sale of products or services directly from a marketing company associated with the marketing system to the first participant, and storing the accounting in the first data record; causing, by the computer, first rewards points to be credited to the first participant based on the accounted for sale to the first participant, the first rewards points redeemable for products, services, or compensation associated with the marketing system, and stored in the first data record; and causing, by the computer, second rewards point to be credited to the first participant based on the accounted sale to the first participant if the first data record is assigned the first attribute, the second rewards point redeemable for products, services, or compensation associated with the second marketing system and stored in a partner merchant file on the computer.

### RELATED APPLICATIONS

The present patent document claims the benefit of the filing date under 35 U.S.C. §119(e) of Provisional U.S. Patent Application Ser. No. 60/546,613, filed Feb. 20, 2004, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright © 2004, Alticor, Inc., All Rights Reserved.

### BACKGROUND

Teenagers are a large and influential part of the consumer market. There are an estimated 40 million teens and tweens in the United States. It is estimated that teens spent $172 billion in 2001, up from $151 billion in 2000. Virtually all teens' money is disposable, and teens are increasingly making purchases online.

Many members of direct marketing systems have teenage children that want to help their parents by purchasing items from the system. Historically, however, teens have not been significantly involved in their parents direct marketing systems because those systems have underserved them. First, teens are brand conscious. Most direct marketing sites do not offer the brands teens want because the sites are targeted at older demographics. Second, typical direct marketing systems employ complicated reward systems that may be confusing to teens that are new to direct marketing concepts. Third, legal barriers exist that prevent typical direct marketing websites from contracting with teenagers.

Accordingly, there is a need for a simple, straightforward direct marketing system that may be applicable to teenagers, complies with legal requirements for marketing to minors, and can leverage existing direct marketing systems to generate a member base.

### BRIEF SUMMARY

The present invention is defined by the following claims, and nothing in this section should be taken as a limitation on those claims. By way of introduction, the preferred embodiments described below relate to a method of marketing and selling products or services through a marketing system is disclosed. The method may include: maintaining, by the marketing system, a database in a memory of a computer, the database including a plurality of data records, each data record associated with a participant of the marketing system and assigned a first attribute if the associated participant is also a member of a second marketing system; receiving, at an interface of the computer coupled with the memory, from a first participant, a request to register in the marketing system, the request including an indication that the first participant is also a member of the second marketing system; creating, by the computer, a first data record in the database based on the received request, the first data record being associated with the first participant and assigned the first attribute based on the indication; accounting, by the computer, for a sale of products or services directly from a marketing company associated with the marketing system to the first participant, and storing the accounting in the first data record; causing, by the computer, first rewards points to be credited to the first participant based on the accounted for sale to the first participant, the first rewards points redeemable for products, services, or compensation associated with the marketing system, and stored in the first data record; and causing, by the computer, second rewards point to be credited to the first participant based on the accounted sale to the first participant if the first data record is assigned the first attribute, the second rewards point redeemable for products, services, or compensation associated with the second marketing system and stored in a partner merchant file on the computer.

In a second aspect, a computer implemented system for marketing and selling products or services through a marketing system may be provided. The computer implemented system may include a processor, a memory coupled with the processor and an interface coupled with the processor and the memory. The computer implemented system may include: first logic stored in the memory and executable by the processor to receive, via the interface, a registration of a first individual in the marketing system, the registration including an indication that the first individual is a member of a second marketing system; second logic, coupled with the first logic, stored in the memory and executable by the processor to receive the registration and create, in a database stored in the memory, a first record associated with the first individual and comprising a first identifier identifying the first individual as belonging to the marketing system and a second identifier identifying the first individual as belonging to the second marketing system; third logic stored in the memory and executable by the processor to facilitate selling products or services directly to the first individual from a marketing company associated with the marketing system; fourth logic, coupled with the third logic, stored in the memory and executable by the processor to account for purchases of marketing system products or services by the first individual; and fifth logic, coupled with the fourth logic and the database, stored in the memory and executable by the processor to credit the first individual with first reward points based on the accounted for purchases, the first rewards points redeemable for products, services, or compensation associated with the marketing system and to save the first reward points to the first record, the fifth logic being further executable to credit the first individual with second rewards points based on the accounted for purchases and the second identifier, the second rewards points redeemable for products, services, or compensation associated with the second marketing system and to store the second reward points in a merchant partner file in the memory.

### BRIEF DESCRIPTION OF THE DRAWINGS

FIG. 1 is an overview of the logical architecture for one embodiment of a direct marketing system;

FIG. 2 is a screen shot of a welcome page of one embodiment of a web based front-end for a direct marketing system;

FIG. 3 is an exemplary screen shot of a shopping cart page;

FIG. 4 is a logical overview of the business processes of a direct marketing system;

FIG. 5 is an exemplary sponsorship hierarchy for members of a direct marketing system;

FIG. 6 depicts two exemplary sponsorship hierarchies for members of a direct marketing system;

FIG. 7 is a logical overview of the point accumulation business processes of a direct marketing system;

FIG. 8 is an exemplary rewards point calculation for a purchase from a direct marketing system;

FIG. 9 is an exemplary rewards point calculation for a purchase from a partner store to a direct marketing system;

FIG. 10 is an exemplary redemption supplementation calculation for a rewards purchase;

FIG. 11 is a logical overview of the alternative point accumulation business processes of a direct marketing system; and

FIG. 12 is an exemplary calculation of alternative points for a purchase from a partner store to a direct marketing system.

### DETAILED DESCRIPTION OF THE DRAWINGS AND THE PRESENTLY PREFERRED EMBODIMENTS

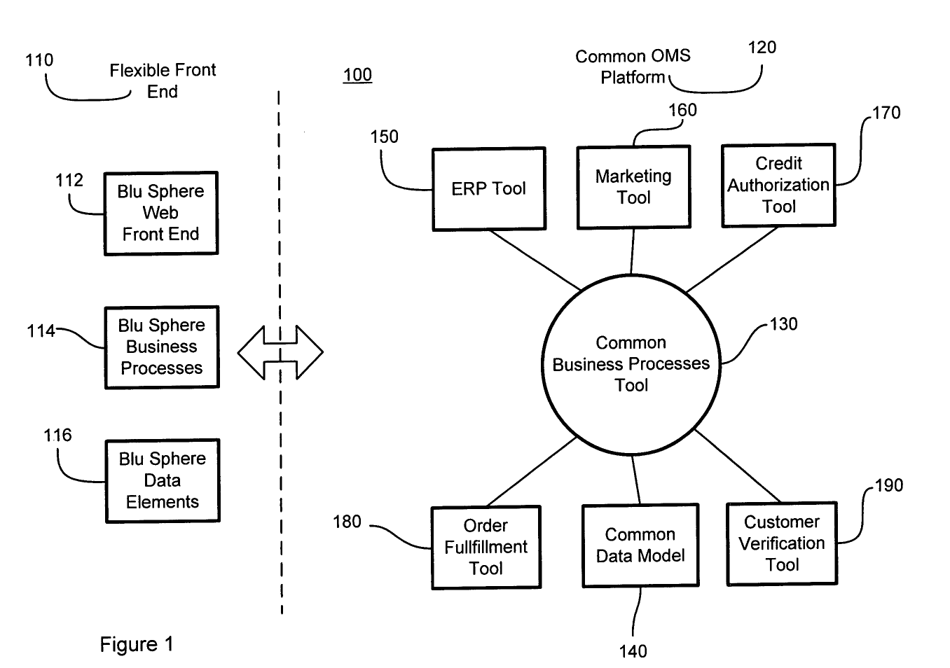

FIG. 1 shows an overview of the logical architecture of a direct marketing e-commerce system 100. The system 100 includes a front-end subsystem 110 and an order management system 120. The front-end system 110 includes a web-based front end 112, front-end business processes 114, and data elements 116. The web-based front-end 112 includes the HTML files, graphics and the like to provide a user-interface to the direct marketing system 100. The front-end business processes 114 include the software necessary to provide the functionality of the direct marketing system 100. This functionality includes calculating the rewards applicable to a purchase, enrolling new members, and the like, described in more detail below. The data elements 116 define the various data objects used by the business processes 114, such as customer information, orders, credit card authorization requests, customer verification requests and the like. The data elements may be stored in a database (not shown).

The order management system 120 includes the tools necessary to provide standard order management capabilities for an e-commerce website, such as order fulfillment, inventory control, credit authorizations and the like. The order management system 120 is coupled with the front-end system 111 via the common business processes tool 130. Herein, the phrase “coupled with” is defined to mean directly connected to or indirectly connected with through one or more intermediate components. Such intermediate components may include both hardware and software based components. The common business processes tool 130, described in more detail below, coordinates the communications between the front-end system 110 and the various system resources provided by the order management system 120. These communications occur using a common data model 140 to allow various front-end systems 110 to share the resources provided by the order management system 120.

In one embodiment, the resources provided by the order management system 120 include an Enterprise Resource Planning (ERP) tool 150, a marketing tool 160, a credit authorization tool 170, an order fulfillment tool 180, and a customer verification tool 190. The ERP tool 150 includes software for providing manufacturing, order entry, accounts receivable and payable, general ledger, purchasing, warehousing, transportation and/or human resources services. The marking tool 160 includes software for analyzing customer activity, measuring the success of product promotions, and the like. The credit authorization tool 170 includes software for securing credit card authorizations. Optionally, the credit authorization tool may be coupled with a fraud detection system to detect potentially fraudulent transactions. The order fulfillment tool 180 provides order fulfillment and logistics services. Optionally, the order fulfillment tool may be coupled to an additional marketing tool 140. The customer verification tool 190 allows the order management system 120 to verify customer status levels, personal information and the like.

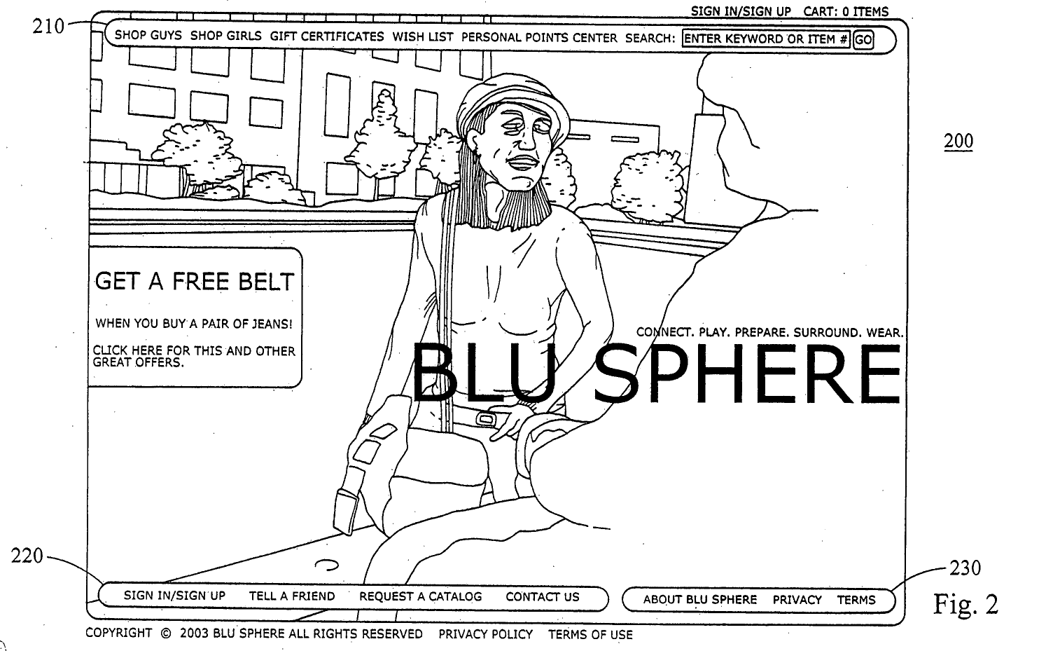

Referring now to FIG. 2, a screen shot of a welcome page 200 of one embodiment of a web based front-end 112 is shown. The welcome page 200 includes the main navigational tools for the web based front-end 112. A navigation bar 210 including links to various section of the website may be provided. In the embodiment of FIG. 2, links are provided to a ‘shop guys’ section, a ‘shop girls’ section, a gift certificates section, a wish list section, and a ‘Personal Points Center’ section. The ‘shop guys’ section of the website includes product information pages and the like for products most likely to purchased by male shoppers. Similarly, the ‘shop girls’ section of the website includes product information pages and the like for products for products most likely to be purchased by female shoppers. The gift certificates section includes pages for purchasing gift certificates for use on the website. The wish list section includes pages for generating a wish list of products a shopper desires to purchase at a future point in time. The ‘Personal Points Center’ section includes pages for administering a shopper's reward points account, described in more detail below. In one embodiment, this section is a password protected section of the website. Additionally, a search tool may be provided to allow a user to search the website for products and information by keyword or item number.

Additionally, a navigation bar 220 may also be provided that includes links to various administrative tools. In the embodiment of FIG. 2, the navigation bar 220 includes links for signing in/signing up, telling a friend, requesting a catalog, and contacting the website administrators. The sign in/sign up link allows a shopper to register as a member of the direct marketing system 100, or allows an existing member to sign into the website. The ‘tell a friend’ link allows a user to email information about the website to other people. As described below, members may earn reward points for referring new members to the system 100. The request a catalog link allows a user to request a paper or electronic catalog of the items offered for sale by the direct marketing system 100. A third navigation bar 230 may also be provided to allow a user to access information about the direct marketing system, such as privacy policies, terms of use and the like.

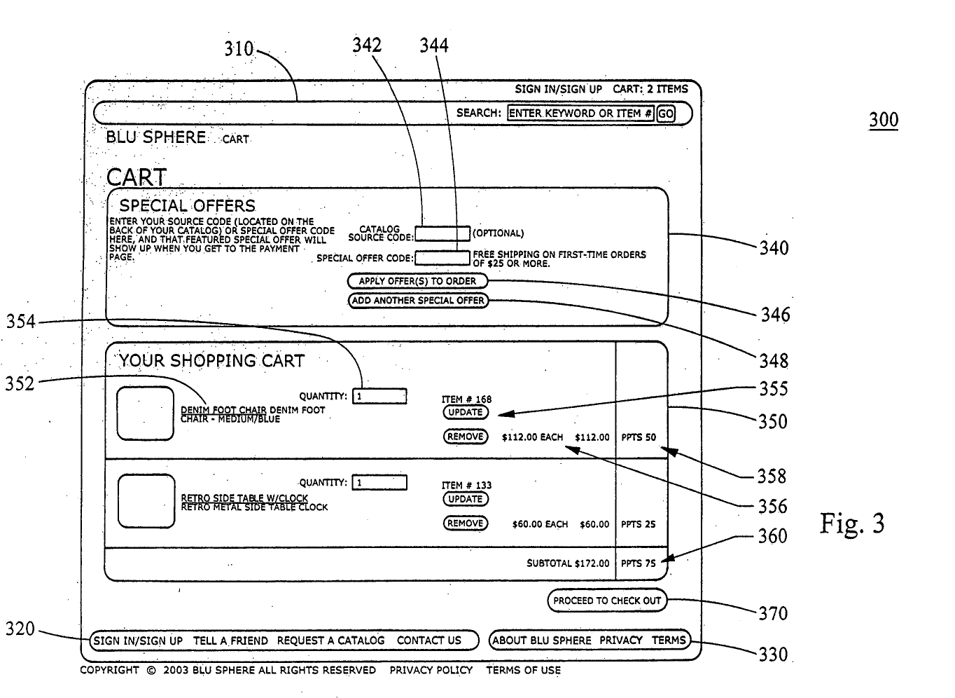

In one embodiment, items are selected for purchase using a known shopping cart method. A shopper may view items in their shopping cart. Referring now to FIG. 3, an exemplary screen shot of a shopping cart page 300 containing items to be purchased is shown. While viewing the items currently in their shopping cart, shoppers may navigate to various sections of the direct marketing system 100 website via the navigation bars 310 and 320, as described above. Additionally, controls 340 may be provided to allow the user to take advantage of special offers being made by the direct marketing system. For example, a shopper may enter special catalog codes or the shopper may enter any other special codes in the appropriate text box 342 and 344, respectively. The shopper may then apply the entered code to the currently selected items by selecting the apply offer button 346, or input another code by selecting the add another offer button 348.

For each item in the shopping cart, various product information 350 is displayed. In one embodiment, product name and description information 352 is displayed, as well as quantity information 354. The shopper may edit the quantities by inputting a using the quantity controls 355. Additionally, the price 356 for the selected item is displayed. The per item price may be displayed, a total price for the desired quantity of the item may be displayed, or a combination of the two may be displayed. Finally, the total reward points 358 to be earned if the shopper purchases the desired quantity of the item is displayed. Order totals 360 may be displayed for both the total cost and total reward points of the selected items and quantities may be displayed.

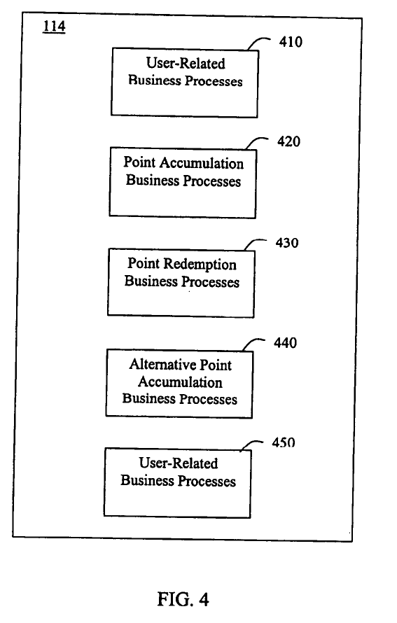

Referring now to FIG. 4, a logical overview of the business processes 114 is shown. In one embodiment, the front-end business processes 114 are divided into four categories. These categories are the user-related business processes 410, the point accumulation business processes 420, the point redemption business processes 430, the alternative point accumulation business processes 440, and the point reversal business processes 450. It should be apparent to one of ordinary skill in the art that other business processes are contemplated, such as general e-commerce related business processes for order processing and the like.

The user-related processes 410 include all the user administration processes, such as the processes for registering new users and for maintaining inter-relationships among the users. In one embodiment, there is one level of membership in the direct marketing system 100. To register, a member creates an account by providing the appropriate information. For example, a user may be required to provide a username, password, contact information, and the like in order to create an account on the system 100. In response, the system may create a record associated with the member. Optionally, the member may also specify a referral ID that denotes an additional member who referred the currently registering user to the system 100. The referral ID may be any type of identifier, for example, a member ID, number, or email address. The member may change their referral ID at any time. In one embodiment, the referral ID may be a member ID or number for a member of another direct marketing system. In cases where the referral ID is a member ID for another direct marketing system, the referring party does not have to be member of the direct marketing system 100. If no referral ID is specified, the member may be sponsored by the system 100 itself, i.e. any activities of the member that generate points for the referring party, as described below, may be calculated and stored in a common pool. Members linked by referral IDs are linked in a hierarchical arrangement, forming a group of associated members.

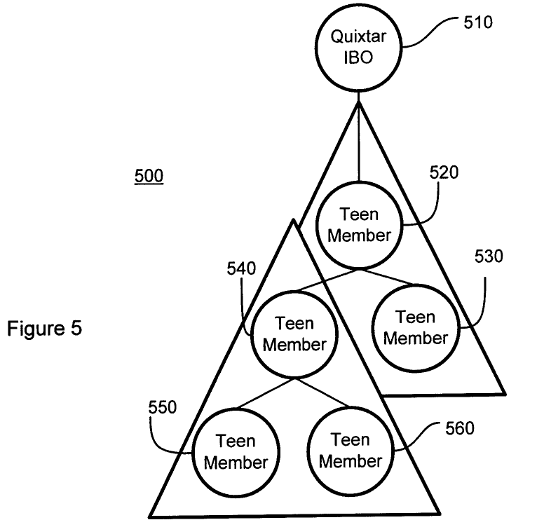

Referring now to FIG. 5, an exemplary sponsorship hierarchy 500 is shown. In general, a member may accumulate reward points from the direct marketing system 100 based on that member's activities and the activities of any member specifying them in the referral ID. Members of other direct marketing systems may also earn reward points from those systems from the activities of any member in the hierarchy. In the embodiment of FIG. 5, the sponsorship hierarchy begins with an Independent Business Owner 510, or IBO. An IBO 510 may or may not be a member that is also registered in another direct marketing system. Examples of other direct marketing systems are described in U.S. patent application Ser. No. 09/515,860 entitled “Electronic Commerce Transactions Within a Marketing System That May Contain a Membership Buying Opportunity” to Arganbright et al, and U.S. patent application Ser. No. 09/515,861 entitled “Method for Marketing and Selling that May Contain a Membership Buying Opportunity” to Arganbright et al. As stated above, the IBO 510 may or may not be a member of the direct marketing system 100. The member 520 is a member of the direct marketing system 100, and has specified a referral ID corresponding to the IBO's 510 member number for the other direct marketing system. Accordingly, activities of the member 520 may generate points for the IBO 510, as described below. Alternatively, a member may specify another member ID as the referring party. For example, members 530 and 540 have specified the ID for another member 520 in the referral ID. The activities of members 530 and 540 may generate points for the direct marketing system 100 for the referring party, member 520, as well as points for another direct marketing system for the IBO 510, as discussed below. Similarly, members 550 and 560 have specified member 540 as referring them to the system 100. Accordingly, the activities of members 550 and 560 may generate rewards for the direct marketing system 100 for member 540 and for another direct marketing system for the IBO 510.

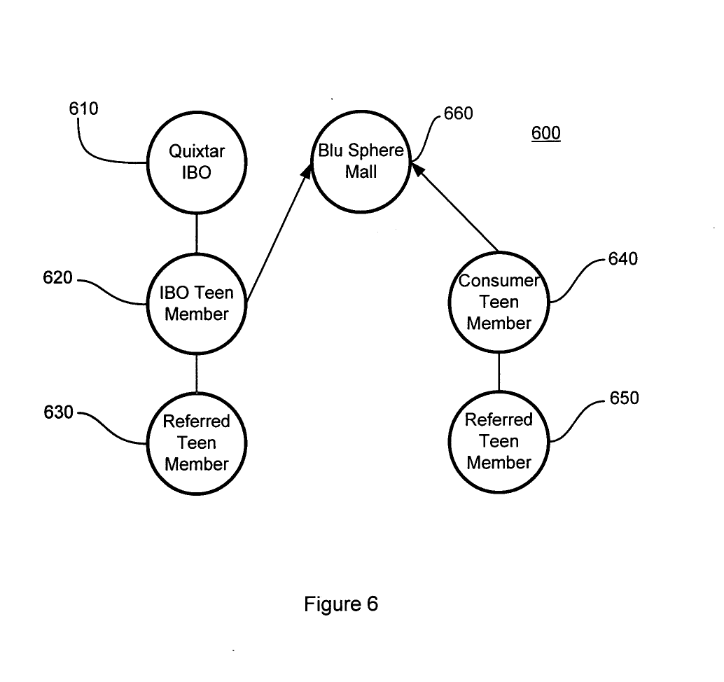

Sponsorship hierarchies may begin with an IBO or a member. FIG. 6 depicts two sponsorship hierarchies, one that begins with an IBO 610 and another that begins with a member 640. As above, a member 620 specifies the IBO 610 in the referral ID, and another member 630 specifies member 620 in the referral ID. As will be described below, the activities of members 630 may generate reward points from the direct marketing system 100 for member 620, and the activities of both members 620 and 630 may generate points for the IBO 610 for another direct marketing system. These activities may include, for example, purchasing items from an online mall 660 associated with the system 100. Additionally, a second hierarchy is shown in which member 640 registers for the system 100 without specifying anyone in the referral ID and member 650 registers for the system 100 specifying the un-referred member 640 in the referral ID. Here, the activities of the member 650 may generate reward points for the system 100 for the referring member 640. However, the IBO 610 may not receive rewards for another direct marketing system for the activities of the members 640 and 650 because those members 640 and 650 are not part of the IBO's 610 hierarchy.

All members of the direct marketing system 100 can earn reward points for various activities in accordance with the point accumulation processes 420. Points that are earned and authorized for redemption may be used to redeem special products in accordance with the point redemption business processes 430. Reward points are categorized by status level, and may be classified as ‘earned active’, ‘earned pending’, ‘redeemed pending’, and ‘redeemed’. ‘Earned active’ points may be used to purchase the special redemption products. ‘Earned pending points’ are points that have been earned but cannot be redeemed until a condition is met, for example, expiration of a 30-day waiting period. ‘Redeemed pending’ points are points that have been redeemed but are in transit, for example, the redemption order is being fulfilled. ‘Redeemed’ points are points that have been redeemed and the corresponding redemption order has been shipped.

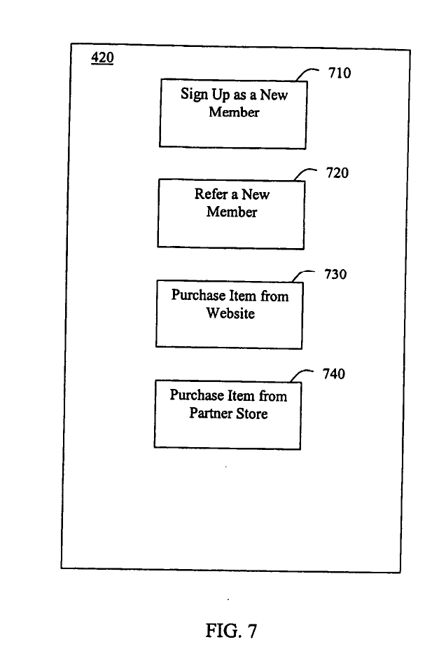

Points are earned in accordance with the point accumulation processes 420. Referring to FIG. 7, a logical overview of the point accumulation business processes is shown. In one embodiment points may be earned for signing up as a new member (710), referring a new member (720), purchasing an item from the direct marketing system 100 website (730), or purchasing an item from a partner store to the direct marketing system 100 (740). A member that registers as a new member (710) may receive a fixed amount of points, for example, 100 points. These points may be immediately redeemable, or may be subject to a condition.

A member that refers a new member (720) may earn a fixed amount of points, for example, 100 points. These points may be immediately redeemable, or may be subject to a condition. To qualify for these points, the new member must specify the referring member in the referral ID portion of the registration process. In one embodiment, these points may be prefaced on the new user making at least one purchase of a specific dollar amount, for example, $50. The referring member may receive the points even if the first purchase is less than the specified amount, so long as the new member places a single order of the specified amount. Thus, the referring member will receive referral points when the referred member places a qualifying order. Referral points may be earned once per new member referred, or may be earned each time a referred member places a qualifying order.

Members may also earn points by purchasing items from the direct marketing system website (730). Each product includes a corresponding reward point value. In one embodiment, point values correspond to the dollar amount of the given product. For example, a point may be earned for each dollar spent. Alternatively, products may be assigned associated reward point values for any reason. In this manner, special deals may be offered to members that reward the purchase of certain items with a large number of points. Points earned from purchased may be immediately redeemable, or may be subject to a condition. In one embodiment, these points are subject to a 30-day delay.

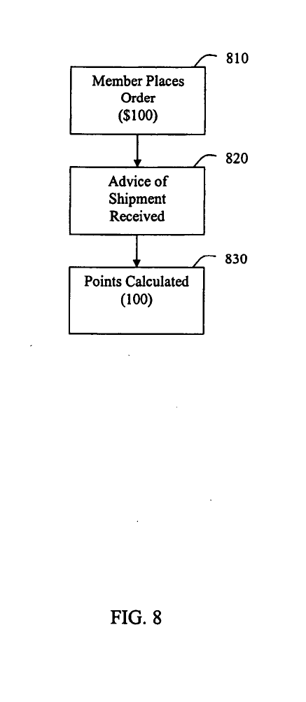

Referring now to FIG. 8, an exemplary rewards point calculation for a typical purchase is shown. First, the member places an order for $100 worth of merchandise (810). Next, the order is fulfilled and an Advice of Shipment is received from the fulfillment process (820). The member's account is credited with 100 points (1 point for each dollar) (830). Since these points are subject to a 30-day delay, the points are ‘earned pending’ points, and the date on which these points may be redeemed may be shown in a points administration tool. After the 30-delay is met, the points may be redeemed.

Members may also earn points by purchasing items from a partner store to the direct marketing system website (740). Each partner store product includes a corresponding reward point value. In one embodiment, point values correspond to the dollar amount of the given product. For example, a point may be earned for each dollar spent. Alternatively, products may be assigned associated reward point values for any reason. In this manner, special deals may be offered to members that reward the purchase of certain items with a large number of points. Points earned from purchases may be immediately redeemable, or may be subject to a condition. In one embodiment, these points are subject to a 30-day delay. Points earned at each partner store may be calculated using the same formula, or points earned at each partner store may be calculated using a store specific formula.

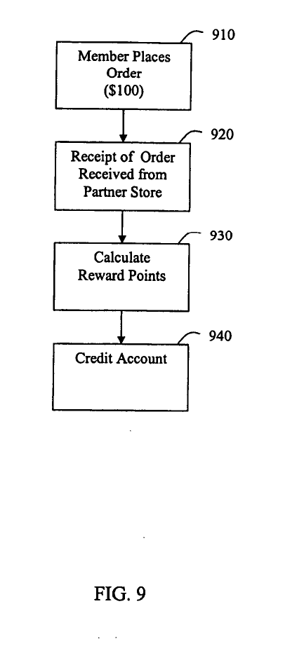

Referring now to FIG. 9, an exemplary rewards point calculation for a typical purchase from a partner store is shown. First, the member places an order on a partner store for $100 worth of merchandise (910). Next, receipt of the order is received from the partner store (920). Reward points are calculated for the transaction (930). In one embodiment, points are calculated based on multiplying the order subtotal (total dollar value of the order-shipping costs-handling costs-tax) by a partner store conversion rate. The partner store conversion rate may be the same for each partner store, or each partner store may have an associated partner conversion rate. The member's account is credited with the points (940). Since these points are subject to a 30-day delay, the points are ‘earned pending’ points, and the date on which these points may be redeemed may be shown in a points administration tool. After the 30-delay is met, the points may be redeemed.

Points are redeemed in accordance with the redemption business processes 430. In one embodiment, points may only be redeemed for special products offered through a redemption store subsection of the direct marketing system 100. Accordingly, the prices associated with the products offered through the redemption store will be displayed in points and will include shipping, handling and tax. In order to differentiate between the regular products and the redemption products, separate shopping carts may be used, as known in the art.

Optionally, a member may supplement the purchase of a product from the redemption store subsection with a credit card if the member does not have enough points to purchase the desired items. A point conversion ratio may be used to determine the price of each point. A minimum point threshold may be enforced before a member will be allowed to supplement their redemption purchase with a credit card. Each reward item will have an associated minimum point threshold. In one embodiment, this threshold may be approximately 50% of the normal cost in points of the item. For example, if a product cost 100 points, the minimum point threshold for the item may be 50 points. Alternatively, the minimum point threshold for a given rewards product may range from 0 points to the normal cost of the item.

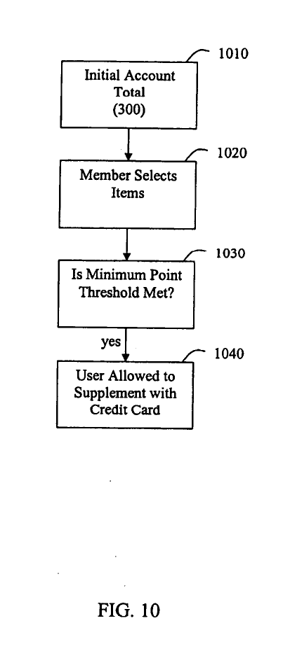

Referring to FIG. 10, an exemplary redemption supplementation calculation for a rewards purchase is shown. Initially, the member has 300 points available to redeem (1010), and selects three items worth 100, 50 and 200 points respectively (1020). Assume that the point conversion ratio is 0.05, so that the cost per point is $0.05. Minimum point thresholds for each of the products are calculated and totaled (1030). In this example, the minimum point thresholds for each product are 40, 10 and 100, respectively, so the minimum point threshold for the entire order is 150. If the member has enough points to meet the minimum point threshold, but does not have enough points to purchase the items outright with points, the member will be prompted to supplement their purchase with a credit card (1040). In this case, the member will be asked to purchase an additional 50 points at $0.05 each, for a total of $2.50. The member will then have the option to purchase the additional points or modify their order. If the order is supplemented and approved, the order information is saved in a redemption order table. Exemplary information to be saved includes general order information, the total points redeemed for the order, the total points purchased for the order, and the total cost in dollars charged to the member's credit card. Item information, such as item identifiers, point costs, and minimum point thresholds may also be saved.

Alternative points are generated in accordance with the alternative point accumulation business processes 440. As stated earlier, members may specify an IBO as the referring party, and each IBO may earn points for another direct marketing system for the activities of all members in their sponsorship hierarchy. Each time an order is placed from a member in a sponsorship hierarchy with an IBO, the order information and an IBO identifier is saved in a merchant partner file and forwarded to the other direct marketing system at regular intervals, for example, once a month. In one embodiment, the merchant partner file is forward to an agent of the direct marketing system via email. The other direct marketing system then processes the file to calculate the appropriate bonus. Alternatively, all orders may be saved to the merchant partner file and the activities of members in a sponsorship hierarchy without an IBO may be pooled in a general account and distributed all IBOs in the other direct marketing system. In one embodiment, the other direct marketing system is the Quixtar direct marketing system, and the alternative points are personal value/business volume (PV/BV) points associated with Quixtar.

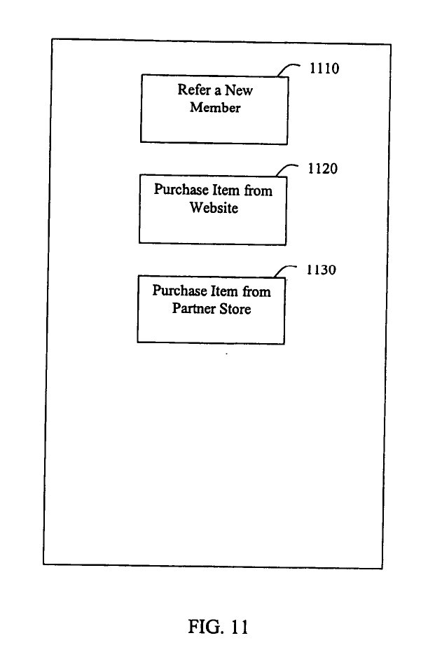

Referring to FIG. 11, a logical overview of the alternative point accumulation business processes of a direct marketing system 100 is shown. In one embodiment points may be earned for referring a new member (1110), purchasing an item from the direct marketing system 100 website (1120), or purchasing an item from a partner store to the direct marketing system 100 (1130). A member that refers a new member (1110) may earn points for other direct marketing systems in accordance with their scoring systems. To qualify for these points, the new member must specify the referring member in the referral ID portion of the registration process. In one embodiment, these points may be earned each time a referred member places an order from either the direct marketing system 100 website or from a partner store.

A member of the direct marketing system 100 may also be a member of another direct marketing system, such as an IBO in the Quixtar direct marketing system. In such a case, the member will earn reward points for purchases made from either the direct marketing system 100 website (1120) or a partner store (1130) for both the direct marketing system 100 as well as alternative points from the other direct marketing system, for example, PV/BV from Quixtar. Each order from a partner store (1130) will be adjusted according to a partner store conversion rate, as described above.

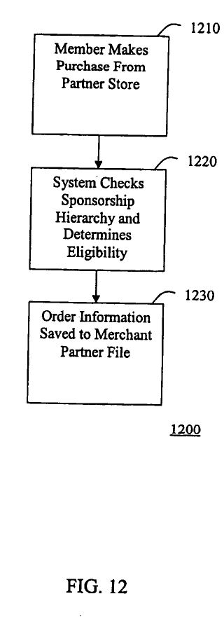

Referring to FIG. 12, an exemplary calculation (1200) of alternative points for a purchase from a partner store is shown. In the embodiment of FIG. 12, the member is an IBO affiliated with Quixtar and the points being calculated are PV/BV. A member makes a purchase (1210) a partner store. In this example, the order total is $125, $100 for the items to be purchased and $25 for shipping, handling and tax. The system then checks to see if the referral ID, or the referral ID of any member in the members sponsorship hierarchy, corresponds to an IBO and is thus eligible to receive alternative points (1220). If the order qualifies, a partner store conversion rate is applied to the order subtotal. In this case, a 25% partner store conversion rate is applied. Next, the order information is entered into the merchant partner file (1230). In order for the alternative points to be credited to the IBO, the order information will show an order placed by the IBO, regardless of which member in the IBO's sponsorship hierarchy actually placed the order. Here, the entry will be made to reflect a $25 ($100×25%) order placed by the IBO. The merchant partner file is then forwarded to Quixtar for the actual calculation of PV/BV in accordance with Quixtar business processes.

If a member returns an item purchased from the direct marketing system 100, points are subtracted from the member's total points in accordance with the point reversal business processes 450. When an item is returned, the points earned for that item are subtracted from the member's point account, regardless of the total number of points in the member's account. Thus, the member may be left with negative points. Return information will be forwarded to other direct marketing systems for purchases that qualify for alternative points from those systems.

It is therefore intended that the foregoing detailed description be regarded as illustrative rather than limiting, and that it be understood that it is the following claims, including all equivalents, that are intended to define the spirit and scope of this invention.

1. A method of marketing and selling products or services through a marketing system comprising:
maintaining, by the marketing system, a database in a memory of a computer, the database including a plurality of data records, each data record associated with a participant of the marketing system and assigned a first attribute if the associated participant is also a member of a second marketing system;
receiving, at an interface of the computer coupled with the memory, from a first participant, a request to register in the marketing system, the request including an indication that the first participant is also a member of the second marketing system;
creating, by the computer, a first data record in the database based on the received request, the first data record being associated with the first participant and assigned the first attribute based on the indication;
accounting, by the computer, for a sale of products or services directly from a marketing company associated with the marketing system to the first participant, and storing the accounting in the first data record;
causing, by the computer, first rewards points to be credited to the first participant based on the accounted for sale to the first participant, the first rewards points redeemable for products, services, or compensation associated with the marketing system, and stored in the first data record; and
causing, by the computer, second rewards point to be credited to the first participant based on the accounted sale to the first participant if the first data record is assigned the first attribute, the second rewards point redeemable for products, services, or compensation associated with the second marketing system and stored in a partner merchant file on the computer.

2. The method of claim 1, wherein a data record associated with a participant may be further associated with one or more data records, each associated with another participant, the method further comprising:
associating, in the database, the first data record with a plurality of other data records, each associated with another participant, the participants associated with each of the plurality of data records belonging to a group associated with the first participant.

3. The method of claim 2 further comprising:
accounting, by the computer, for a sale of products and services to the participants associated with the plurality of other data records and storing the accounting in the first data record based on the accounting;
causing, by the computer, first rewards points to be credited to the first participant based on the accounted for sale to the participants associated with the plurality of other data records, the first reward points stored in the first data record; and
causing, by the computer, second rewards point to be credited to the first participant based on the accounted sale to the participants associated with the plurality of other data records if the first data record is assigned the first attribute, the second rewards point stored in the partner merchant file.

4. The method of claim 1 further comprising:
receiving, by the computer, a return indication indicating the return of a product or service of the sale by the first participant,
causing, by the computer, first rewards points to be debited from the first participant based on the return indication, and stored in the first data record;
causing, by the computer, second rewards point to be debited from the first participant based on the return indication if the first data record is assigned the first attribute, the second rewards stored in the partner merchant file.

5. The method of claim 1 further comprising
receiving, at an interface of the computer coupled with the memory, from a second participant, a second request to register in the marketing system, the second request indicative of an association between the first participant and the second participant;
creating, by the computer, a second data record in the database based on the second request, the second data record being associated with the second participant and the first data record; and
causing, by the computer, first rewards points to be credited to the first participant based on the creating of the second data record, the first rewards points stored in the first data record.

6. The method of claim 5 further comprising:
accounting, by the computer, for a sale of products or services directly from the marketing company associated with the marketing system to the second participant, and storing the accounting in the second data record,
holding in abeyance the first reward points based on the creating of the second record until the accounting is stored in the second data record.

7. The method of claim 6, wherein the first reward points based on the creating of the second record are held in abeyance until the accounting meets a threshold value.

8. The method of claim 1 further comprising:
accounting, by the computer, for a sale of products or services from a partner store associated with the marketing system to the first participant, and storing the accounting in the first data record;
causing, by the computer, first rewards points to be credited to the first participant based on the accounted for sale to the first participant, the first rewards points stored in the first data record.

9. The method of claim 8, wherein the first reward points are credited to the first participant are further based on a partner store conversion rate.

10. The method of claim 1 further comprising
receiving, at the interface of the computer, from the first participant, a request to redeem first reward points for a product or service associated with the marketing system, the product or service having an associated reward point value;
determining, by the computer, if the reward points stored in the first data record meets or exceed the associated reward point value; and
causing, by the computer, an amount of first reward points equal to the associated reward point value to be debited from the first participant if the reward points in the first data record meets or exceed the associated reward point value.

11. The method of claim 10 further comprising
providing, by the computer, an option to purchase additional first reward points to the first participant if the reward points in the first data record is lower than the associated reward point value.

12. The method of claim 11, wherein the option to purchase additional first reward points is only provided to the first participant if the first reward points stored in the first data record meet a threshold point total.

13. The method of claim 12, wherein the threshold point total is zero.

14. The method of claim 1 further comprising:
causing, by the computer, first rewards points to be credited to the first participant based on the creating of the first data record, the first rewards points stored in the first data record.

15. A computer implemented system for marketing and selling products or services through a marketing system, the computer implemented system comprising a processor, a memory coupled with the processor and an interface coupled with the processor and the memory, the computer implemented system further comprising:
first logic stored in the memory and executable by the processor to receive, via the interface, a registration of a first individual in the marketing system, the registration including an indication that the first individual is a member of a second marketing system;
second logic, coupled with the first logic, stored in the memory and executable by the processor to receive the registration and create, in a database stored in the memory, a first record associated with the first individual and comprising a first identifier identifying the first individual as belonging to the marketing system and a second identifier identifying the first individual as belonging to the second marketing system;
third logic stored in the memory and executable by the processor to facilitate selling products or services directly to the first individual from a marketing company associated with the marketing system;
fourth logic, coupled with the third logic, stored in the memory and executable by the processor to account for purchases of marketing system products or services by the first individual; and
fifth logic, coupled with the fourth logic and the database, stored in the memory and executable by the processor to credit the first individual with first reward points based on the accounted for purchases, the first rewards points redeemable for products, services, or compensation associated with the marketing system and to save the first reward points to the first record,
the fifth logic being further executable to credit the first individual with second rewards points based on the accounted for purchases and the second identifier, the second rewards points redeemable for products, services, or compensation associated with the second marketing system and to store the second reward points in a merchant partner file in the memory.

16. The marketing system of claim 15, wherein a data record of the database associated with the first individual may be further associated with one or more data records, each associated with another participant,
wherein the third logic is further executable to associate, in the database, the first data record with a plurality of other data records, each associated with another individual, the individuals associated with each of the plurality of data records belonging to a group associated with the first individual.

17. The marketing system of claim 16, wherein the fourth logic is further executable to account for purchases of marketing system products or services by the individuals associated with the plurality of other data records;
the fifth logic being further executable to credit first reward points to the first individual based on the accounted for purchases by the individuals associated with the plurality of other data records and to store the first reward points in the first record,
the fifth logic being further executable to credit second reward points to the first individual based on the accounted for purchases by the individuals associated with the plurality of other data records and the second identifier, and to store the second reward points in the merchant partner file.

18. The marketing system of claim 15, wherein the fourth logic is further executable to account for returns of marketing system products or services by the first individual, the marketing system further comprising:
sixth logic, coupled with the fourth logic and the database, stored in the memory and executable by the processor to debit the first individual with first reward points based on the accounted for returns and to store the first reward points in the first record,
the sixth logic further executable to debit the first individual with second reward points based on the accounted for returns and the second identifier and to store the second reward points in the merchant partner file.

19. The marketing system of claim 15, wherein the first logic is further executable to receive, via the interface, a second registration of a second individual in the marketing system,
wherein the second logic is further executable to receive the second registration and create, in the database, a second record associated with the second individual and comprising a third identifier identifying the first individual as belonging to the marketing system, and
wherein the fifth logic is further executable to credit the first individual with first reward points based on the creation of the second record and to store the first reward points in the first record.

20. The marketing system of claim 19, wherein the third logic is further executable to facilitate selling products or services directly to the second individual from the marketing company associated with the marketing system,
wherein the fourth logic is further executable to account for purchases of marketing system products or services by the second individual, and
wherein the fifth logic is further executable to credit the first individual with first reward points based on the creation of the second record and the accounted for purchases of marketing system products or services by the second individual and to store the first reward points in the first record.

21. The direct marketing system of claim 20, wherein the fifth logic is further executable to credit the first individual with first reward points if the accounted for purchases of marketing system products or services by the second individual meets a threshold value.

22. The direct marketing system of claim 15, wherein the third logic is further executable to facilitate selling products or services to the first individual from a partner store associated with the marketing system,
wherein the fourth logic is further executable to account for purchases of partner store products or services by the second individual, and
wherein the fifth logic is further executable to credit the first individual with first reward points based on the accounted for purchases of partner store products or services by the first individual and to store the first reward points in the first record.

23. The direct marketing system of claim 22, wherein the first reward points are credited to the first individual in accordance with a conversion factor for the partner store.

24. The direct marketing system of claim 15, wherein the first logic is further executable to receive, via the interface, a redemption request of the first individual to redeem reward points for a marketing system product or service, the marketing system product or service having an associated reward point value, the marketing system further comprising:
sixth logic, coupled with the database, stored in the memory and executable by the processor to compare an amount of first reward points in the first record with the associated reward point value and to debit, from the first individual, first reward points equal to the associated reward point value if the amount of first reward points meets or exceeds the associated reward point value.

25. The direct marketing system of claim 24, wherein the first logic is further executable to, via the interface, provide an option to purchase additional first reward points to the first participant,
wherein the sixth logic is further coupled to the first logic and executable to command the first logic to provide the option if the amount of first reward points in the first record is lower than the associated amount of reward points.

26. The direct marketing system of claim 25, wherein the sixth logic is further executable to command the first logic to provide the option if the amount of first reward points in the first record meets or exceeds a threshold point total.

27. The direct marketing system of claim 26, wherein the threshold point total is zero.

28. The direct marketing system of claim 26, wherein the fifth logic is further executable to credit the first individual with first rewards points based on the creating of the first record and to store the first rewards points in the first record.
